(19) United States
(12) Patent Application Publication
(10) Pub. No.: US 2020/0181422 A1
(43) Pub. Date: Jun. 11, 2020

(54) NON-FLUORINATED WATER-BASED COMPOSITIONS WITH PLANT-BASED MATERIALS FOR GENERATING SUPERHYDROPHOBIC SURFACES

(71) Applicants: Kimberly-Clark Worldwide, Inc., Neenah, WI (US); The Board of Trustees of the University of Illinois, Chicago, IL (US)

(72) Inventors: Constantine Michael Megaridis, Oak Park, IL (US); Jared Morrissette, Chicago, IL (US); Patrick Carroll, Chicago, IL (US); Ilker S. Bayer, Genova (IT); Jian Qin, Appleton, WI (US); Donald E. Waldroup, Roswell, GA (US); Corey T. Cunningham, Larsen, WI (US)

(21) Appl. No.: 16/641,586

(22) PCT Filed: Aug. 31, 2017
(86) PCT No.: PCT/US2017/049667

§ 371 Date: Feb. 24, 2020

(51) Int. Cl. C09D 5/02; C09D 7/65; C09D 7/40; C09D 123/02; C09D 133/02; C09D 191/06; C09D 137/00; C09D 4/00

(52) U.S. Cl. CPC C09D 5/022; C09D 7/65; C09D 7/68; C09D 7/69; C09D 4/00; C09D 123/02; C09D 133/02; C09D 191/06; C09D 137/00; C09D 7/70

(57) ABSTRACT

A non-fluorinated composition configured to create a superhydrophobic surface includes a hydrophobic matrix component free of fluorine; filler particles, wherein the filler particles are plant-based elements of a size ranging from 100 nm to 100 μm; and water, wherein the hydrophobic matrix component is in an aqueous dispersion. Also, a non-fluorinated composition configured to create a superhydrophobic surface includes a hydrophobic matrix component free of fluorine, wherein the hydrophobic matrix component includes a polyolefin, a natural wax, or a synthetic wax; filler particles, wherein the filler particles are plant-based elements of a size ranging from 100 nm to 100 μm; an emulsifier; and water, wherein the hydrophobic component is in an aqueous dispersion.

### BACKGROUND

The present disclosure relates to surfaces that exhibit superhydrophobic properties when treated with a fluorine-free composition applied with a water-based, non-organic solvent.

A superhydrophobic surface exhibits a sessile water contact angle of greater than 150°. If, additionally, the surface exhibits a water droplet roll-off (sliding) angle of less than 10°, the surface is deemed to be “self-cleaning.” In nature, lotus leaves exhibit such properties (so-called lotus effect). Most man-made materials such as fabrics, nonwovens, cellulose tissues, polymer films, etc., do not have surfaces with such properties. Currently, there are several methods to modify a non-superhydrophobic surface to achieve the lotus effect. One method is to graft hydrophobic polymer(s) (using a fluorinated monomer, co-monomers, etc.) onto every exposed surface of a non-superhydrophobic material. Such a method makes the material superhydrophobic throughout the thickness of the material, which might not be desired in most cases. It is also not cost effective, cannot be used for a continuous production, and can lead to undesirable environment issues.

The development and implementation of water-based, non-fluorinated formulations for bio-inspired superhydrophobic surface treatments can greatly reduce the adverse environmental impact typically associated with their synthesis. Over the past several decades, many approaches to these superhydrophobic surfaces have been developed that commonly require harsh organic solvents, complex processing methods, and/or environmentally undesirable fluorinated chemistry. In addition, many of the demonstrated methods are not relevant in practice on large scales in commercial application, not only for their negative consequences to the environment, but also the inability to economically prepare large-area fluid repellent surfaces at sufficiently low-cost. Imparting liquid repellency via large-area approaches, such as spray-casting or size press coating, have been shown to be viable for low-cost and substrate-independent fluid management.

A standard approach is to coat a specially-formulated liquid dispersion onto a surface. Upon subsequent drying, a nano-structured superhydrophobic film forms. To use such an approach, the deposited film must exhibit a chemical and physical morphology characteristic of superhydrophobic surfaces. First, the formulation requires at least one low-surface energy (i.e., hydrophobic) component, and second, the treated surface has to have a rough surface texture, preferably extending over several length-scales characteristic of micro- and/or nano-roughness. Although various formulated dispersions capable of achieving a superhydrophobic surface exist, rarely are they purely water-based and they generally contain harmful fluorinated compounds to reduce surface energy.

Low-cost, large-area superhydrophobic coating treatments are of great value to many applications requiring a passive means for attaining efficient liquid repellency. While many applications are envisioned, only few are realizable due to either the high-cost or low-durability of such treatments. Recently, spray deposition of polymer-particle dispersions has been demonstrated as an excellent means for producing low-cost, large-area, durable, superhydrophobic composite coatings/films; however, the dispersions used for spray deposition of superhydrophobic coatings generally contain harsh or volatile solvents. Solvents are required for wet processing of polymers, as well as for dispersing hydrophobic nanoparticles, thus inhibiting scalability due to the increased cost in chemical handling and safety concerns. This problem can be overcome by replacing solvents with water, but this situation is paradoxical: producing a highly water-repellent coating from an aqueous dispersion.

Also, such coatings usually contain fluoropolymers. A low-surface energy fluoropolymer (e.g., fluoroacrylic copolymers, poly(tetrafluoroethylene), etc.) is typically incorporated into the formulation to achieve liquid repellency. However, concerns over their bio-persistence have provided an impetus for eliminating these chemicals. The problems with the byproducts of fluoropolymer degradation, e.g. long-chain perfluorinated acids (PFAs) that have a documented ability to bioaccumulate, as well as the potential adverse effects PFA in maternal concentrations can have on human offspring, have led to a shift in the manufacture and usage of fluoropolymers. One common PFA of particular concern is perfluorooctanoic acid (PFOA). In 2006, the EPA introduced its PFOA (perfluorooctanoic acid) Stewardship Program and invited eight major fluoropolymer and telomer manufacturers to commit to eliminating precursor chemicals that can break down into PFOA; in one case, DuPont has since introduced so-called short-chain chemistry, whereby the length of perfluorinated chains within polymers are kept below a threshold in order to avoid degradation into PFOA. In other applications, usage of fluoropolymers in products that come in sustained contact with the human body or in disposable items intended for landfilling after consumption must be minimized.

In addition, various nanoparticles are undesirable from a processing standpoint due to their ability to become airborne and ingested, and are likewise undesirable for the end-user for the same size-scale related reasons. In prior examples, a water-based fluorine-free superhydrophobic formulation was developed that included a polyolefin dispersion and graphene nanoplatelets and that exhibited a water contact angle greater than 150 degree. The black color of the graphene nanoplatelets, however, made using such a chemistry undesirable. Another formulation was also developed to overcome this color issue by instead using titanium dioxide nanoparticles. This new formulation did not have the color issue but cannot be processed in an open air operation process. That limits its application in many common coating/printing procedures due to an instability issue. Therefore, a water-based fluorine-free superhydrophobic formulation without the color and processing issues is needed.

### SUMMARY

Using a waterborne, wax-based approach eliminates the need for fluorinated compounds, and incorporating cellulosic elements has made possible a superhydrophobic surface treatment that does not include the issues outlined above. This novel, environmentally-friendly composite is herein characterized as having potential in numerous fluid management applications by virtue of its simplicity, efficiency, and versatility.

For a multitude of safety, health, economic, and environmental issues, it is important both that the dispersion be fully aqueous-based when regarding commercial scale production, as this will decrease concerns associated with the use of organic solvents and fluoropolymers.

The presence of a water-based and entirely fluorine-free superhydrophobic formulation capable of large-area surface modification has been lacking in the literature and in commercial application, and for this reason has been developed and herein been characterized.

The present disclosure relates to a superhydrophobic non-fluorinated composition including a hydrophobic matrix component free of fluorine, hydrophilic filler elements, wherein the filler elements are cellulosic fibers or particles, and water, wherein the hydrophobic component is in an aqueous dispersion.

The present disclosure also relates to a non-fluorinated composition configured to create a superhydrophobic surface, the composition including a hydrophobic matrix component free of fluorine; filler particles, wherein the filler particles are plant-based elements of a size ranging from 100 nm to 100 μm; and water, wherein the hydrophobic matrix component is in an aqueous dispersion.

The present disclosure also relates to a non-fluorinated composition configured to create a superhydrophobic surface, the composition including a hydrophobic matrix component free of fluorine; filler particles, wherein the filler particles are plant-based elements of a size ranging from 100 nm to 100 μm, and wherein the plant-based elements are micro- and nano-fibrillated cellulose; and water.

The present disclosure also relates to a non-fluorinated composition configured to create a superhydrophobic surface, the composition including a hydrophobic matrix component free of fluorine, wherein the hydrophobic matrix component includes a polyolefin, a natural wax, or a synthetic wax; filler particles, wherein the filler particles are plant-based elements of a size ranging from 100 nm to 100 μm; an emulsifier; and water, wherein the hydrophobic component is in an aqueous dispersion.

### BRIEF DESCRIPTION OF THE FIGURES

The foregoing and other features and aspects of the present disclosure and the manner of attaining them will become more apparent, and the disclosure itself will be better understood by reference to the following description, appended claims and accompanying drawings, where:

FIG. 1 schematically illustrates a coating process using the formulations of the present disclosure;

FIG. 2A illustrates the phase inversion process used in conjunction with formulations of the present disclosure;

FIG. 2B photographically illustrates using scanning electron microscope (SEM) images the phase inversion process of FIG. 2A;

FIG. 2C illustrates the x-ray photoelectron spectroscopy (XPS) spectra of the phase inversion process of FIG. 2A;

FIG. 2D illustrates the Fourier transform infrared (FTIR) spectroscopy spectra of the phase inversion process of FIG. 2A;

FIG. 3 graphically illustrates advancing and receding contact angles (θₐ and θ_{f}, respectively) as a function of mass fraction for an NFC-DPOD formulation;

FIG. 4 graphically illustrates advancing and receding contact angles (θₐ and θ_{f}, respectively) as a function of mass fraction for an MNFC-DPOD formulation;

FIG. 5 is an SEM photographic illustration of NFC;

FIG. 6 is an SEM photographic illustration of MNFC;

FIG. 7 graphically illustrates contact angles for MNFC-AKD after 4M NH₄OH treatment;

FIG. 8A is an SEM photographic illustration of MNFC-AKD at the scale shown in bottom right of the image (8 μm), as described further below;

FIG. 8B is an SEM photographic illustration of MNFC-AKD at the scale shown in bottom right of the image (8 μm), as described further below;

FIG. 8C is an SEM photographic illustration of MNFC-AKD at the scale shown in bottom right of the image (8 μm), as described further below;

FIG. 8D is an SEM photographic illustration of MNFC-AKD at the scale shown in bottom right of the image (8 μm), as described further below;

FIG. 8E is an SEM photographic illustration of MNFC-AKD at the scale shown in bottom right of the image (8 μm), as described further below;

FIG. 8F is an SEM photographic illustration of MNFC-AKD at the scale shown in bottom right of the image (8 μm), as described further below;

FIG. 9 is an SEM photographic illustration of coating morphology for MCC-DPOD-09 (left column) and MCC-DPOD-09-A05 (right column);

FIG. 10 graphically illustrates the apparent water contact angle (en as a function of the mass fraction (φ) of MCC in a formulation of OM MCC:DPOD and a formulation of 0.5M MCC:DPOD;

FIG. 11 graphically illustrates the apparent water contact angle (en as a function of the mass fraction (φ) of MCC in a formulation of OM MCC:AKD and a formulation of 4M MCC:AKD;

FIG. 12 graphically illustrates the apparent water contact angle (en as a function of the mass fraction (φ) of MCC in a formulation of OM MCC:DPOD:AKD and a formulation of 4M MCC:DPOD:AKD;

FIG. 13 shows scanning electron microscopy images of lycopodium with (a) carnauba wax and (b) beeswax, where left and right columns correspond to low and high magnification, respectively;

FIG. 14 graphically illustrates the apparent water contact angle (en as a function of the mass fraction (φ) of lycopodium in a formulations with carnauba wax and beeswax; and

FIG. 15 graphically illustrates contact angles for a blend of MCC-PERFORMALENE 400 polyethylene wax emulsion, with the MCC mass fraction given on the horizontal.

Repeat use of reference characters in the present specification and drawings is intended to represent the same or analogous features or elements of the present disclosure. The drawings are representational and are not necessarily drawn to scale. Certain proportions thereof might be exaggerated, while others might be minimized.

### DETAILED DESCRIPTION

All percentages are by weight of the total solid composition unless specifically stated otherwise. All ratios are weight ratios unless specifically stated otherwise.

The term “superhydrophobic” refers to the property of a surface to repel water very effectively. This property is quantified by a water contact angle exceeding 150°. It should be noted that reference to a superhydrophobic composition does not necessarily mean that the composition itself is superhydrophobic, particularly if it is a water-based composition, but that the composition, when properly applied to a surface, can make the surface superhydrophobic.

The term “hydrophobic,” as used herein, refers to the property of a surface to repel water with a water contact angle from about 90° to about 120°.

The term “hydrophilic,” as used herein, refers to surfaces with water contact angles well below 90°.

The term “self-cleaning,” as used herein, refers to the property to repel water with the water roll-off angle on a tilting surface being below 10°.

As used herein, the term “nonwoven web” or “nonwoven fabric” means a web having a structure of individual fibers or threads that are interlaid, but not in an identifiable manner as in a knitted web. Nonwoven webs have been formed from many processes, such as, for example, meltblowing processes, spunbonding processes, air-laying processes, coforming processes and bonded carded web processes. The basis weight of nonwoven webs is usually expressed in ounces of material per square yard (osy) or grams per square meter (gsm) and the fiber diameters are usually expressed in microns, or in the case of staple fibers, denier. It is noted that to convert from osy to gsm, osy must be multiplied by 33.91.

As used herein the term “spunbond fibers” refers to small diameter fibers of molecularly oriented polymeric material. Spunbond fibers can be formed by extruding molten thermoplastic material as fibers from a plurality of fine, usually circular capillaries of a spinneret with the diameter of the extruded fibers then being rapidly reduced as in, for example, U.S. Pat. No. 4,340,563 to Appel et al., and U.S. Pat. No. 3,692,618 to Dorschner et al., U.S. Pat. No. 3,802,817 to Matsuki et al., U.S. Pat. Nos. 3,338,992 and 3,341,394 to Kinney, U.S. Pat. No. 3,502,763 to Hartman, U.S. Pat. No. 3,542,615 to Dobo et al, and U.S. Pat. No. 5,382,400 to Pike et al. Spunbond fibers are generally not tacky when they are deposited onto a collecting surface and are generally continuous. Spunbond fibers are often about 10 microns or greater in diameter. However, fine fiber spunbond webs (having an average fiber diameter less than about 10 microns) can be achieved by various methods including, but not limited to, those described in commonly assigned U.S. Pat. No. 6,200,669 to Marmon et al. and U.S. Pat. No. 5,759,926 to Pike et al.

Meltblown nonwoven webs are prepared from meltblown fibers. As used herein the term “meltblown fibers” means fibers formed by extruding a molten thermoplastic material through a plurality of fine, usually circular, die capillaries as molten threads or filaments into converging high velocity, usually hot, gas (e.g. air) streams that attenuate the filaments of molten thermoplastic material to reduce their diameter, which can be to microfiber diameter. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Buntin. Meltblown fibers are microfibers that can be continuous or discontinuous, are generally smaller than 10 microns in average diameter (using a sample size of at least 10), and are generally tacky when deposited onto a collecting surface.

As used herein, the term “polymer” generally includes, but is not limited to, homopolymers, copolymers, such as for example, block, graft, random and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic and random symmetries.

As used herein, the term “multicomponent fibers” refers to fibers or filaments that have been formed from at least two polymers extruded from separate extruders but spun together to form such fibers. Multicomponent fibers are also sometimes referred to as “conjugate” or “bicomponent” fibers or filaments. The term “bicomponent” means that there are two polymeric components making up the fibers. The polymers are usually different from each other, although conjugate fibers can be prepared from the same polymer, if the polymer in each state is different from the other in some physical property, such as, for example, melting point, glass transition temperature or the softening point. In all cases, the polymers are arranged in purposefully positioned distinct zones across the cross-section of the multicomponent fibers or filaments and extend continuously along the length of the multicomponent fibers or filaments. The configuration of such a multicomponent fiber can be, for example, a sheath/core arrangement, wherein one polymer is surrounded by another, a side-by-side arrangement, a pie arrangement or an “islands-in-the-sea” arrangement. Multicomponent fibers are taught in U.S. Pat. No. 5,108,820 to Kaneko et al.; U.S. Pat. No. 5,336,552 to Strack et al.; and U.S. Pat. No. 5,382,400 to Pike et al. For two component fibers or filaments, the polymers can be present in ratios of 75/25, 50/50, 25/75 or any other desired ratios.

As used herein, the term “multiconstituent fibers” refers to fibers that have been formed from at least two polymers extruded from the same extruder as a blend or mixture. Multiconstituent fibers do not have the various polymer components arranged in relatively constantly positioned distinct zones across the cross-sectional area of the fiber and the various polymers are usually not continuous along the entire length of the fiber, instead usually forming fibrils or protofibrils that start and end at random. Fibers of this general type are discussed in, for example, U.S. Pat. Nos. 5,108,827 and 5,294,482 to Gessner.

As used herein, the term “substantially continuous fibers” is intended to mean fibers that have a length that is greater than the length of staple fibers. The term is intended to include fibers that are continuous, such as spunbond fibers, and fibers that are not continuous, but have a defined length greater than about 150 millimeters.

As used herein, the term “staple fibers” means fibers that have a fiber length generally in the range of about 0.5 to about 150 millimeters. Staple fibers can be cellulosic fibers or non-cellulosic fibers. Some examples of suitable non-cellulosic fibers that can be used include, but are not limited to, polyolefin fibers, polyester fibers, nylon fibers, polyvinyl acetate fibers, and mixtures thereof. Cellulosic staple fibers include for example, pulp, thermomechanical pulp, synthetic cellulosic fibers, modified cellulosic fibers, and the like. Cellulosic fibers can be obtained from secondary or recycled sources. Some examples of suitable cellulosic fiber sources include virgin wood fibers, such as thermomechanical, bleached and unbleached softwood and hardwood pulps. Secondary or recycled cellulosic fibers can be obtained from office waste, newsprint, brown paper stock, paperboard scrap, etc., can also be used. Further, vegetable fibers, such as abaca, flax, milkweed, cotton, modified cotton, cotton linters, can also be used as the cellulosic fibers. In addition, synthetic cellulosic fibers such as, for example, rayon and viscose rayon can be used. Modified cellulosic fibers are generally composed of derivatives of cellulose formed by substitution of appropriate radicals (e.g., carboxyl, alkyl, acetate, nitrate, etc.) for hydroxyl groups along the carbon chain.

As used herein, the term “pulp” refers to fibers from natural sources, such as woody and non-woody plants. Woody plants include, for example, deciduous and coniferous trees. Non-woody plants include, for example, cotton, flax, esparto grass, milkweed, straw, jute, hemp, and bagasse.

As used herein, “tissue products” are meant to include facial tissue, bath tissue, towels, hanks, napkins, and the like. The present disclosure is useful with tissue products and tissue paper in general, including but not limited to conventionally felt-pressed tissue paper, high bulk pattern densified tissue paper, and high bulk, uncompacted tissue paper.

Superhydrophobic surfaces, whether made by chemically or physically modifying a pre-existing surface or by coating the surface with a superhydrophobic component, exhibit extreme water repellency. This sort of water repellency, or hydrophobicity, can only be achieved by properly tuning/modifying the surface energy and surface roughness of the surface, where low surface energy and hierarchical roughness (micro- and nano-scale) are most favorable. Developing a surface with these characteristics can be challenging, especially when constrained by environmental concerns. The fabrication process of superhydrophobic surfaces are typically complicated in their use, for example, of chemical processing, and involve the use of harmful solvents. This is mainly due to the fact that most of the surfaces rely on either fluorine or silane chemistries that, although great options for lowering a surface's intrinsic surface energy, are difficult or impossible to implement into an environmentally- and consumer-friendly material system. Disclosed herein are water-based, fluorine-free coating formulations that make use of a waterborne hydrophobic polymer or blend of polymers along with various types of cellulose. When the coating formulations are sprayed onto a substrate, the cellulose provides the roughness component needed for superhydrophobicity, while the hydrophobic polymer contributes to the low surface energy requirement. The performance of formulations can be further enhanced by adding small amounts of a pH-adjusting component (e.g., ammonium hydroxide). The added pH adjustor can make the formulation more stable and/or augment the hydrophobicity of the formulation.

Current formulations used to prepare a substrate to demonstrate superhydrophobicity require harmful fluorinated polymers in conjunction with solvents that include harmful volatile organic compounds (VOCs). The present disclosure solves these problems for these applications by using more preferable polymers, such as polyolefins (e.g., polyethylene (PE)), and water-borne solvents to minimize the use of harmful VOCs, a common, non-trivial problem with coatings aiming to achieve superhydrophobicity upon deposition. The present disclosure builds on the work described in co-pending U.S. Patent Application Publication Nos. 2014/0323002 and 2014/0323633, which are incorporated herein by reference to the extent they do not conflict herewith.

The present disclosure describes a water-based, non-fluorinated dispersion for the formation of superhydrophobic composite coatings from spray or from any other suitable method. Spray deposition of polymer composite coatings is described for illustrative purposes only and has been demonstrated as a low-cost, large area process for modifying the wettability (e.g., superhydrophobicity, superoleophobicity), electrical conductivity, and EMI shielding capabilities of surfaces. Any other suitable method of delivering a coating can be used herein.

A superhydrophobic surface of the present disclosure can be produced on a substrate by treating the substrate with a non-fluorinated composition including a hydrophobic component free of fluorine, a filler element, and water. The composition can also include a stabilizing compound. The hydrophobic component is preferably in an aqueous dispersion. As a result, the composition can be free of volatile organic compounds (VOCs).

The study of functional nanoparticle-polymer composites has been aided in large part by the advancement in synthesis methods for polymers as well as greater control over nanoparticle dimensions and purities. These composites have been used for a wide range of applications, such as enhanced heat transfer, low electrical resistance, and radiation absorption. For liquid-repellent functionality, specifically to water, the surface requires low surface energies and a suitable degree of roughness to reduce the liquid-to-solid interfacial contact area, thus increasing the contact angle of water droplets used as a measure of surface wettability. The wettability of a smooth un-textured surface in an air environment is determined by the free surface energies of the liquid and solid being introduced; whether the surface is hydrophobic or hydrophilic, the interaction with water is tunable via the surface roughness imparted by the addition of nanomaterials. A high-degree of surface roughness modifies the intrinsic wettability of the surface into two extreme cases, referred to as either superhydrophobic or superhydrophilic having contact angles to water of greater than 150° or less than 10°, respectively. The polymer has the direct role in an applied composite of determining the affinity of liquid(s) to a given surface, as well as forming the matrix for any ensconced nanomaterials within.

In practice until recently, the fabrication of super-repellent composites requiring polymers with sufficiently low surface energies (i.e., for repelling water, γ<<72 mN/m) demanded the use of harsh solvents for wet-processing, thus hindering the development of entirely water-based systems. Fluorine-free and water-compatible polymer systems capable of delivering low surface energy have been the primary challenge for the development of truly environmentally-benign superhydrophobic coatings.

The hydrophobic component is a hydrophobic polymer that is dispersible in water to form the basic elements of the superhydrophobic properties of the present disclosure. The hydrophobic component can be a polymer, a nanoparticle, any other suitable material, or any combination of these. For example, the hydrophobic component can be a polyolefin. The hydrophobic component can also be a co-polymer of olefin and acrylic acid, or a mixture of a polyolefin and a co-polymer of olefin and acrylic acid.

The polymers or hydrophobes of interest in this disclosure include a water-based, polyolefin dispersion (DPOD) (42% in water; DOW HYPOD 8510), an alkyl ketene dimer (AKD) emulsion such as that available from Kemira Chemicals Inc. (FENNOSIZE KD 168N emulsion), and carnauba wax, beeswax, and polyethylene waxes. PEMULEN 1622 emulsifier can be used to make the carnauba wax, beeswax, and PERFORMALENE polyethylene wax wax formulations. PEMULEN emulsifier behaves like a surfactant in these cases, allowing for proper stable dispersions of the hydrophobic waxes in water. Without PEMULEN emulsifier or the like, it is generally not possible to disperse these hydrophobic waxes in water. It should be noted that PEMULEN emulsifier is not a hydrophobe, but it is polymeric.

The composition of the present disclosure includes one or more filler elements. Such filler material, if used, can be hydrophilic. The filler material can include plant-based materials such as cellulose particles or fibers. In particular aspects, the filler material can be micro- and nano-fibrillated cellulose (MNFC) exhibiting diameters approximately between 100 nm and 100 μm and characteristic lengths of several hundred micrometers.

The filler material can also include plant-based materials such as lycopodium. Lycopodium is inherently highly hydrophobic. It can, however, be dispersed in water though probe sonication. Without this pre-treatment step, lycopodium will float on water. It is suspected that by sonicating the lycopodium particles, water becomes entrapped into the particle's structure, and hence allows the particles to be dispersed in water.

Choosing particles having micro- and nano-scale dimensions allows for fine control over surface roughness and a greater reduction in the liquid-to-solid interfacial contact area; for hydrophobic, or low-surface energy surfaces, this translates into an increased resistance to fluid wetting by allowing the solid surface to retain pockets of vapor that limit liquid/solid contact. Many superhydrophobic surfaces fabricated in the literature have utilized hydrophobic particle fillers, necessitating the use of non-aqueous suspensions or other additives. Although these hydrophobic particles aided in generating the repellent roughness, they are not viable in a water-based system without the use of charge-stabilization or surfactants. The hydrophilic MNFC is demonstrated to supply an adequate amount of surface roughness, and is compatible with a waterborne polyolefin polymer wax blend; the polymer acts to conceal the hydrophilicity of suspended MNFC when dispersed, thus sheathing the MNFC in a weakly hydrophobic shell that is maintained once the final composite film has been applied and residual water is removed. Using MNFC of small dimensions (exhibiting diameters approximately between 100 nm and 100 μm), a surface roughness is achieved propelling the contact angles of the final composite upwards into the superhydrophobic regime.

Cellulosic particles and/or fibers of interest in this disclosure include nano-fibrillated cellulose (NFC) from Shanghai University with fiber diameters of about 100 nm to 5 μm, micro/nano-fibrillated cellulose (MNFC) from the North Carolina State University (NCSU): College of Textiles with fiber diameters of about 100 nm to 10 μm, micro-crystalline cellulose (MCC) such as the 20 μm powder available from Sigma-Aldrich, item #310697, α-cellulose (a) powder available from Sigma-Aldrich, item # C8002, and lycopodium (Lyco) available from Sigma-Aldrich, item #19108. NFC is further described in co-pending application “Nanofibrillated Cellulose Fibers” to Qin, et al., filed Aug. 31, 2017 with attorney docket no. 65019712PCT01, which is incorporated herein by reference in to the extent it does not conflict herewith.

The solid components of the present disclosure (i.e., polymer, cellulosic elements) can be present in an amount from about 1.0% to about 3.0%, by weight, of the solution. Such an amount is suitable for spray applications, where higher concentrations of either polymer and/or nanoparticles in the dispersion can lead to either viscoelastic behavior, resulting in either clogging of the spray nozzle or incomplete atomization and fiber formation, or dramatic increases in dispersion viscosity and thus nozzle clogging. When a different surface coating technology is used, e.g. dipping, the range might be different. For example, if a size press coating is used, use of a higher percentage of the solid components is preferred. The range can be in an amount from about 1.0% to about 10%. It should be noted that this range is not fixed and that it is a function of the materials being utilized and the procedure used to prepare the dispersion. When a higher amount of the polymer is used, the surface structure is less desirable as it lacks the proper texture to be superhydrophobic. When a lower amount of the polymer is used, the binding is less desirable, as the coating behaves more so as a removable powder coating.

The composition of the present disclosure eliminates the use of an organic solvent by carefully selecting the appropriate combination of elements to impart the superhydrophobic characteristics. Preferably, the non-organic solvent is water. Any type of water can be used; however, demineralized or distilled water can be opted for use during the manufacturing process for enhanced capabilities and a reduction in possible contaminants that could alter performance of the coating. The use of water helps to reduce the safety concerns associated with making commercial scale formulations including organic solvents. For example, due to the high volatility and flammability of most organic solvents, eliminating such use in the composition reduces production safety hazards.

Additionally, production costs can be lowered with the elimination of ventilation and fire prevention equipment necessitated by organic solvents. Raw material costs can be reduced in addition to the transportation of such materials as an added advantage to using the non-organic solvent formulation to arrive at the present disclosure.

Additionally, because water is considered a natural resource, surfaces treated with a solvent including water as its base can be considered healthier and better for the environment. The formulation used to treat the surface of the present disclosure includes greater than about 90%, greater than about 95%, or about 99% water, by weight of the dispersion composition.

The composition of the present disclosure can also include a pH adjustor. pH adjustors of interest in the present disclosure include ammonium hydroxide (NH₄OH) and aminomethyl propanol (AMP), available from Sigma-Aldrich, item #08581.

The formulation within the present disclosure can be additionally treated with a stabilizing agent to promote the formation of a stable dispersion when other ingredients are added to it. The stabilizing agent can be a surfactant, a polymer, or mixtures thereof. If a polymer acts as a stabilizing agent, it is preferred that the polymer differ from the hydrophobic component used within the base composition previously described.

Additional stabilizing agents can include, but are not limited to, cationic surfactants such as quaternary amines; anionic surfactants such as sulfonates, carboxylates, and phosphates; or nonionic surfactants such as block copolymers containing ethylene oxide and silicone surfactants. The surfactants can be either external or internal. External surfactants do not become chemically reacted into the base polymer during dispersion preparation. Examples of external surfactants useful herein include, but are not limited to, salts of dodecyl benzene sulfonic acid and lauryl sulfonic acid salt. Internal surfactants are surfactants that do become chemically reacted into the base polymer during dispersion preparation. An example of an internal surfactant useful herein includes 2, 2-dimethylol propionic acid and its salts.

In some aspects, the stabilizing agent used within the composition can be used in an amount ranging from greater than zero to about 60%, by weight of the hydrophobic component. For example, long chain fatty acids or salts thereof can be used from about 0.5% to about 10% by weight based on the amount of hydrophobic component. In other aspects, ethylene-acrylic acid or ethylene-methacrylic acid copolymers can be used in an amount up to about 80%, by weight based of hydrophobic component. In yet other aspects, sulfonic acid salts can be used in an amount from about 0.01% to about 60% by weight based on the weight of the hydrophobic component. Other mild acids, such as those in the carboxylic acid family (e.g., formic acid), can also be included in order to further stabilize the dispersion. In an aspect that includes formic acid, the formic acid can be present in amount that is determined by the desired pH of the dispersion wherein the pH is less than about 6.

Hydrophobic components such as polymers and nanoparticles can be stabilized in water by using chemicals that include acid functional groups (e.g., acrylic acid, carboxylic acid), and that can become ionized in water under proper pH control (pH>7). The stabilizing compound can be KOH, NH₃(aq), any other suitable material, or any combination of these. The use of such polymers as hydrophobic components is possible by introducing pendant carboxylic acid functional groups that can be charge-stabilized by increasing the pH of the dispersing medium (water); in short, acid functional groups form negative carboxylate ions, thus creating charge repulsion and ultimately stabilization. Carboxylic acid groups also act to promote adhesion with polar surfaces.

In further aspects, PEMULEN emulsifier can be used as a stabilizer/surfactant. Other types of polymers/surfactants can be used as well to stabilize the wax particles. In other aspects, PEMULEN emulsifier-like polymers and similar chemistries can also be used (e.g., varieties of alkyl acrylate cross-polymer and PEG/PPG copolymers). Further, incorporating a fatty alcohol (e.g., cetyl, stearyl, lauryl) into the waxes can both soften them and enhance their hydrophobicity.

Once spray-deposited on a substrate with the aqueous component allowed to evaporate or removed through drying or thermal curing, the components become insoluble in water, thus promoting water repellency. Such coatings can find a wide range of applications due to their benign processing nature, as well as the wide variety of substrates on which they can be deposited.

The particular example described herein is an all-water-based, non-fluorinated superhydrophobic surface treatment from a sprayable polyethylene copolymer and cellulose dispersion. Such an approach to water-repellent coatings is expected to find wide application within consumer products aiming to achieve simple, low-cost, large-area, environmentally-benign superhydrophobic treatments. It is emphasized that cellulose is employed for its dispersibility in water and compatibility with polyolefin chemistry, but that any high-aspect ratio filler can also be used.

The present disclosure relates to a surface of a substrate, or the substrate itself, exhibiting superhydrophobic characteristics when treated with a formulation including a hydrophobic component, a filler element, and water. The superhydrophobicity can be applied either over the entire surface, patterned throughout or on the substrate material, and/or directly penetrated through the z-directional thickness of the substrate material.

In some aspects of the present disclosure, the substrate that is treated is a nonwoven web. In other aspects, the substrate is a tissue product.

The substrate of the present disclosure can be treated such that it is superhydrophobic throughout the z-directional thickness of the material and is controlled in such a way that only certain areas of the material are superhydrophobic. Such treatment can be designed to control spatial wettability of the material thereby directing wetting and liquid penetration of the material; such designs can be utilized in controlling liquid transport and flow rectification.

Suitable substrates of the present disclosure can include a nonwoven fabric, woven fabric, knit fabric, or laminates of these materials. The substrate can also be a tissue or towel, as described herein. Materials and processes suitable for forming such substrate are generally well known to those skilled in the art. For instance, some examples of nonwoven fabrics that can be used in the present disclosure include, but are not limited to, spunbonded webs, meltblown webs, bonded carded webs, air-laid webs, coform webs, spunlace nonwoven webs, hydraulically entangled webs, and the like. In each case, at least one of the fibers used to prepare the nonwoven fabric is a thermoplastic material containing fiber. In addition, nonwoven fabrics can be a combination of thermoplastic fibers and natural fibers, such as, for example, cellulosic fibers (softwood pulp, hardwood pulp, thermomechanical pulp, etc.). Generally, from the standpoint of cost and desired properties, the substrate of the present disclosure is a nonwoven fabric.

If desired, the nonwoven fabric can also be bonded using techniques well known in the art to improve the durability, strength, hand, aesthetics, texture, and/or other properties of the fabric. For instance, the nonwoven fabric can be thermally (e.g., pattern bonded, through-air dried), ultrasonically, adhesively and/or mechanically (e.g. needled) bonded. For instance, various pattern bonding techniques are described in U.S. Pat. No. 3,855,046 to Hansen; U.S. Pat. No. 5,620,779 to Levy, et al.; U.S. Pat. No. 5,962,112 to Haynes, et al.; U.S. Pat. No. 6,093,665 to Sayovitz, et al.; U.S. Design Pat. No. 428,267 to Romano, et al.; and U.S. Design Pat. No. 390,708 to Brown.

The nonwoven fabric can be bonded by continuous seams or patterns. As additional examples, the nonwoven fabric can be bonded along the periphery of the sheet or simply across the width or cross-direction (CD) of the web adjacent the edges. Other bond techniques, such as a combination of thermal bonding and latex impregnation, can also be used. Alternatively and/or additionally, a resin, latex or adhesive can be applied to the nonwoven fabric by, for example, spraying or printing, and dried to provide the desired bonding. Still other suitable bonding techniques can be described in U.S. Pat. No. 5,284,703 to Everhart, et al., U.S. Pat. No. 6,103,061 to Anderson, et al., and U.S. Pat. No. 6,197,404 to Varona.

In another aspect, the substrate of the present disclosure is formed from a spunbonded web containing monocomponent and/or multicomponent fibers. Multicomponent fibers are fibers that have been formed from at least two polymer components. Such fibers are usually extruded from separate extruders but spun together to form one fiber. The polymers of the respective components are usually different from each other, although multicomponent fibers can include separate components of similar or identical polymeric materials. The individual components are typically arranged in distinct zones across the cross-section of the fiber and extend substantially along the entire length of the fiber. The configuration of such fibers can be, for example, a side-by-side arrangement, a pie arrangement, or any other arrangement.

When utilized, multicomponent fibers can also be splittable. In fabricating multicomponent fibers that are splittable, the individual segments that collectively form the unitary multicomponent fiber are contiguous along the longitudinal direction of the multicomponent fiber in a manner such that one or more segments form part of the outer surface of the unitary multicomponent fiber. In other words, one or more segments are exposed along the outer perimeter of the multicomponent fiber. For example, splittable multicomponent fibers and methods for making such fibers are described in U.S. Pat. No. 5,935,883 to Pike and U.S. Pat. No. 6,200,669 to Marmon, et al.

The substrate of the present disclosure can also contain a coform material. The term “coform material” generally refers to composite materials including a mixture or stabilized matrix of thermoplastic fibers and a second non-thermoplastic material. As an example, coform materials can be made by a process in which at least one meltblown die head is arranged near a chute through which other materials are added to the web while it is forming. Such other materials can include, but are not limited to, fibrous organic materials, such as woody or non-woody pulp such as cotton, rayon, recycled paper, pulp fluff and also superabsorbent particles, inorganic absorbent materials, treated polymeric staple fibers and the like. Some examples of such coform materials are disclosed in U.S. Pat. No. 4,100,324 to Anderson, et al.; U.S. Pat. No. 5,284,703 to Everhart, et al.; and U.S. Pat. No. 5,350,624 to Georger, et al.

Additionally, the substrate can also be formed from a material that is imparted with texture on one or more surfaces. For instance, in some aspects, the substrate can be formed from a dual-textured spunbond or meltblown material, such as described in U.S. Pat. No. 4,659,609 to Lamers, et al. and U.S. Pat. No. 4,833,003 to Win, et al.

In one particular aspect of the present disclosure, the substrate is formed from a hydroentangled nonwoven fabric. Hydroentangling processes and hydroentangled composite webs containing various combinations of different fibers are known in the art. A typical hydroentangling process utilizes high pressure jet streams of water to entangle fibers and/or filaments to form a highly entangled consolidated fibrous structure, e.g., a nonwoven fabric. Hydroentangled nonwoven fabrics of staple length fibers and continuous filaments are disclosed, for example, in U.S. Pat. No. 3,494,821 to Evans and U.S. Pat. No. 4,144,370 to Boulton. Hydroentangled composite nonwoven fabrics of a continuous filament nonwoven web and a pulp layer are disclosed, for example, in U.S. Pat. No. 5,284,703 to Everhart, et al. and U.S. Pat. No. 6,315,864 to Anderson, et al.

Of these nonwoven fabrics, hydroentangled nonwoven webs with staple fibers entangled with thermoplastic fibers is especially suited as the substrate. In one particular example of a hydroentangled nonwoven web, the staple fibers are hydraulically entangled with substantially continuous thermoplastic fibers. The staple can be cellulosic staple fiber, non-cellulosic stable fibers or a mixture thereof. Suitable non-cellulosic staple fibers includes thermoplastic staple fibers, such as polyolefin staple fibers, polyester staple fibers, nylon staple fibers, polyvinyl acetate staple fibers, and the like or mixtures thereof. Suitable cellulosic staple fibers include for example, pulp, thermomechanical pulp, synthetic cellulosic fibers, modified cellulosic fibers, and the like. Cellulosic fibers can be obtained from secondary or recycled sources. Some examples of suitable cellulosic fiber sources include virgin wood fibers, such as thermomechanical, bleached and unbleached softwood and hardwood pulps. Secondary or recycled cellulosic fibers obtained from office waste, newsprint, brown paper stock, paperboard scrap, etc., can also be used. Further, vegetable fibers, such as abaca, flax, milkweed, cotton, modified cotton, cotton linters, can also be used as the cellulosic fibers. In addition, synthetic cellulosic fibers such as, for example, rayon and viscose rayon can be used. Modified cellulosic fibers are generally composed of derivatives of cellulose formed by substitution of appropriate radicals (e.g., carboxyl, alkyl, acetate, nitrate, etc.) for hydroxyl groups along the carbon chain.

One particularly suitable hydroentangled nonwoven web is a nonwoven web composite of polypropylene spunbond fibers, which are substantially continuous fibers, having pulp fibers hydraulically entangled with the spunbond fibers. Another particularly suitable hydroentangled nonwoven web is a nonwoven web composite of polypropylene spunbond fibers having a mixture of cellulosic and non-cellulosic staple fibers hydraulically entangled with the spunbond fibers.

The substrate of the present disclosure can be prepared solely from thermoplastic fibers or can contain both thermoplastic fibers and non-thermoplastic fibers. Generally, when the substrate contains both thermoplastic fibers and non-thermoplastic fibers, the thermoplastic fibers make up from about 10% to about 90%, by weight of the substrate. In a particular aspect, the substrate contains between about 10% and about 30%, by weight, thermoplastic fibers.

Generally, a nonwoven substrate will have a basis weight in the range of about 10 gsm (grams per square meter) to about 200 gsm, more typically, between about 20 gsm to about 200 gsm. The actual basis weight can be higher than 200 gsm, but for many applications, the basis weight will be in the 20 gsm to 150 gsm range.

The thermoplastic materials or fibers, making-up at least a portion of the substrate, can essentially be any thermoplastic polymer. Suitable thermoplastic polymers include polyolefins, polyesters, polyamides, polyurethanes, polyvinylchloride, polytetrafluoroethylene, polystyrene, polyethylene terephthalate, biodegradable polymers such as polylactic acid, and copolymers and blends thereof. Suitable polyolefins include polyethylene, e.g., high density polyethylene, medium density polyethylene, low density polyethylene and linear low density polyethylene; polypropylene, e.g., isotactic polypropylene, syndiotactic polypropylene, blends of isotactic polypropylene and atactic polypropylene, and blends thereof; polybutylene, e.g., poly(1-butene) and poly(2-butene); polypentene, e.g., poly(1-pentene) and poly(2-pentene); poly(3-methyl-1-pentene); poly(4-methyl 1-pentene); and copolymers and blends thereof. Suitable copolymers include random and block copolymers prepared from two or more different unsaturated olefin monomers, such as ethylene/propylene and ethylene/butylene copolymers. Suitable polyamides include nylon 6, nylon 6/6, nylon 4/6, nylon 11, nylon 12, nylon 6/10, nylon 6/12, nylon 12/12, copolymers of caprolactam and alkylene oxide diamine, and the like, as well as blends and copolymers thereof. Suitable polyesters include polyethylene terephthalate, polytrimethylene terephthalate, polybutylene terephthalate, polytetramethylene terephthalate, polycyclohexylene-1,4-dimethylene terephthalate, and isophthalate copolymers thereof, as well as blends thereof. These thermoplastic polymers can be used to prepare both substantially continuous fibers and staple fibers, in accordance with the present disclosure.

In another aspect, the substrate can be a tissue product. The tissue product can be of a homogenous or multi-layered construction, and tissue products made therefrom can be of a single-ply or multi-ply construction. The tissue product desirably has a basis weight of about 10 g/m² to about 65 g/m², and density of about 0.6 g/cc or less. More desirably, the basis weight will be about 40 g/m² or less and the density will be about 0.3 g/cc or less. Most desirably, the density will be about 0.04 g/cc to about 0.2 g/cc. Unless otherwise specified, all amounts and weights relative to the paper are on a dry basis. Tensile strengths in the machine direction can be in the range of from about 100 to about 5,000 grams per inch of width. Tensile strengths in the cross-machine direction are from about 50 grams to about 2,500 grams per inch of width. Absorbency is typically from about 5 grams of water per gram of fiber to about 9 grams of water per gram of fiber.

Conventionally pressed tissue products and methods for making such products are well known in the art. Tissue products are typically made by depositing a papermaking furnish on a foraminous forming wire, often referred to in the art as a Fourdrinier wire. Once the furnish is deposited on the forming wire, it is referred to as a web. The web is dewatered by pressing the web and drying at elevated temperature. The particular techniques and typical equipment for making webs according to the process just described are well known to those skilled in the art. In a typical process, a low consistency pulp furnish is provided from a pressurized headbox, which has an opening for delivering a thin deposit of pulp furnish onto the Fourdrinier wire to form a wet web. The web is then typically dewatered to a fiber consistency of from about 7% to about 25% (total web weight basis) by vacuum dewatering and further dried by pressing operations wherein the web is subjected to pressure developed by opposing mechanical members, for example, cylindrical rolls. The dewatered web is then further pressed and dried by a steam drum apparatus known in the art as a Yankee dryer. Pressure can be developed at the Yankee dryer by mechanical means such as an opposing cylindrical drum pressing against the web. Multiple Yankee dryer drums can be employed, whereby additional pressing is optionally incurred between the drums. The formed sheets are considered to be compacted because the entire web is subjected to substantial mechanical compressional forces while the fibers are moist and are then dried while in a compressed state.

One particular aspect of the present disclosure utilizes an uncreped through-air-drying technique to form the tissue product. Through-air-drying can increase the bulk and softness of the web. Examples of such a technique are disclosed in U.S. Pat. No. 5,048,589 to Cook, et al.; U.S. Pat. No. 5,399,412 to Sudall, et al.; U.S. Pat. No. 5,510,001 to Hermans, et al.; U.S. Pat. No. 5,591,309 to Ruqowski, et al.; U.S. Pat. No. 6,017,417 to Wendt, et al., and U.S. Pat. No. 6,432,270 to Liu, et al. Uncreped through-air-drying generally involves the steps of: (1) forming a furnish of cellulosic fibers, water, and optionally, other additives; (2) depositing the furnish on a traveling foraminous belt, thereby forming a fibrous web on top of the traveling foraminous belt; (3) subjecting the fibrous web to through-air-drying to remove the water from the fibrous web; and (4) removing the dried fibrous web from the traveling foraminous belt.

Conventional scalable methods, such as spraying, can be used to apply a superhydrophobic coating on a surface. Some technical difficulties are typically encountered when spraying water-based dispersions: The first major problem is insufficient evaporation of the fluid during atomization and a high degree of wetting of the dispersion onto the coated substrate, both resulting in non-uniform coatings due to contact line pinning and the so called “coffee-stain effect” when the water eventually evaporates. The second major challenge is the relatively large surface tension of water when compared with other solvents used for spray coating. Water, due to its high surface tension, tends to form non-uniform films in spray applications, thus requiring great care to ensure that a uniform coating is attained. This is especially critical for hydrophobic substrates where the water tends to bead and roll. It was observed that the best approach for applying the aqueous dispersions of the present disclosure was to produce extremely fine droplets during atomization, and to apply only very thin coatings, so as not to saturate the substrate and re-orient hydrogen bonding within the substrate that, after drying, would cause cellulosic substrates (e.g. paper towel) to become stiff.

In another aspect, the coatings are spray cast first on a substrate, such as standard paperboard or other cellulosic substrate; multiple spray passes are used to achieve different coating thicknesses. The sprayed films are then subjected to drying in an oven at about 80° C. for about 30 min to remove all excess water. Once dried, the coatings are characterized for wettability (i.e., hydrophobic vs. hydrophilic). The substrates can be weighed on a microbalance (Sartorius® LE26P) before and after coating and drying in order to determine the minimum level of coating required to induce superhydrophobicity. This “minimum coating” does not strictly mean that the sample will resist penetration by liquids, but rather that a water droplet will bead on the surface and roll off unimpeded. Liquid repellency of substrates before and after coating can be characterized by a hydrostatic pressure setup that determines liquid penetration pressures (in cm of liquid).

### EXAMPLES

The following are provided for exemplary purposes to facilitate understanding of the disclosure and should not be construed to limit the disclosure to the examples.

### Materials

All materials mentioned in Table 1 were used as received. In addition, some materials have expanded descriptions below. Note that in Tables 1 and 2 the superscripts next to an item within the table correspond to relevant information such as: parameter definitions, acronym meanings, concentrations, vendor, item numbers, etc. Formulation ID format is as follows: “Filler”-“Hydrophobe 1”-“Hydrophobe 2”-“Optimal Mass Fraction”-“Chemical treatment.”

TABLE 1
List of formulations and their components

| | | Hydro- | Hydro- | | | pH | | % | | θ | CAH |
|---|---|---|---|---|---|---|---|---|---|---|---|
| Example | Formulation ID | phobe 1 | phobe 2 | Stabilizer | Filler | Adjustor | pH | Solids | φ ¹ | (°) ² | (°) ³ |
| 1 | NFC-DPOD-09 | DPOD⁴ | | | NFC⁵ | | 10 | 3 | 0.9 | 120 | 50 |
| 2 | MNFC-DPOD-09 | DPOD | | | MNFC⁶ | | 10 | 3 | 0.9 | 120 | 60 |
| 3 | MNFC-AKD-075 | AKD⁷ | | Starch⁸ | MNFC | | 6 | 3 | 0.75 | 150 | 40 |
| 4 | MNFC-AKD-05-A4 | AKD | | Starch | MNFC | NH₄OH⁹ | 13 | 3 | 0.5 | 160 | 10 |
| 5 | α-DPOD-085 | DPOD | | | α¹⁰ | | 8 | 2 | 0.85 | 150 | 40 |
| 6 | α-DPOD-085-A05 | DPOD | | | α | NH₄OH | 11 | 2 | 0.85 | 152 | 24 |
| 7 | MCC-DPOD-09 | DPOD | | | MCC¹¹ | | 8 | 2 | 0.9 | 151 | 30 |
| 8 | MCC-DPOD-09-A05 | DPOD | | | MCC | NH₄OH | 11 | 2 | 0.9 | 159 | 15 |
| 9 | MCC-AKD-09 | AKD | | | MCC | | 6 | 3 | 0.9 | | 60 |
| 10 | MCC-AKD-09-A4 | AKD | | | MCC | NH₄OH | 13 | 3 | 0.9 | | 30 |
| 11 | MCC-DPOD-AKD-05 | DPOD | AKD | | MCC | | 8 | 2 | 0.5 | 163 | 60 |
| 12 | MCC-CW-085 | Carnauba | | Pemulen | MCC | AMP¹⁴ | 6 | 3 | 0.85 | 150 | 25 |
| | | Wax¹² | | 1622¹³ | | | | | | | |
| 13 | MCC-BW-085 | Beeswax¹⁵ | | Pemulen | MCC | AMP | 6 | 3 | 0.85 | 145 | 40 |
| | | | | 1622 | | | | | | | |
| 14 | Lyco-CW-075 | Carnauba | | Pemulen | lycopo- | AMP | 6 | 3 | 0.6- | 162 | <5 |
| | | Wax | | 1622 | dium¹⁶ | | | | 0.9 | | |
| 15 | Lyco-BW-075 | Beeswax | | Pemulen | lycopo- | AMP | 6 | 3 | 0.6- | 163 | <5 |
| | | | | 1622 | dium | | | | 0.9 | | |
| 16 | MCC-PF400-075 | Performalene | | Pemulen | MCC | AMP | 6 | 3 | 0.75 | 160 | 80 |
| | | 400¹⁷ | | 1622 | | | | | | | |

¹ Mass fraction (define in the equation below) that provides the best superhydrophobicity
² Apparent sessile Water Contact Angle (WCA)
³ Contact Angle Hysteresis (CAH) - difference between the advancing and receding contact angles, θₐ and θᵣ
⁴Water-based, polyolefin dispersion (DPOD) - (42% in water; DOW; Trade name: HYPOD 8510)
⁵Nano-Fibrillated Cellulose (NFC) produced at Shanghai University (fiber diameter: ~100 nm-5 μm)
⁶Micro/Nano-Fibrillated Cellulose (MNFC) derived from cotton and produced at North Carolina State University (NCSU): College of Textiles (fiber diameter: ~100 nm-10 μm)
⁷Alkyl Ketene Dimer (AKD) emulsion - (Kemira Chemicals Inc.; Trade name: Fennosize KD 168N; 12.5% total solids in water, only 11.2% AKD in water)
⁸Stabilizing component for AKD emulsions
⁹Ammonium Hydroxide (NH₄OH) - (28-30% NH₃ in water; Sigma-Aldrich; Item #: 320145)
¹⁰α-Cellulose (α) - (alpha cellulose powder; Sigma-Aldrich; Item #: C8002)
¹¹Micro-Crystalline Cellulose (MCC) - (microcrystalline powder, 20 μm; Sigma-Aldrich, Item #: 310697)
¹²Carnauba Wax (CW) - (carnauba wax No. 1 yellow, refined; Sigma-Aldrich, Item #: 243213)
¹³Anionic, crosslinked copolymer of acrylic acid and C10-C30 alkyl acrylate. Designed to make stable oil-in-water emulsions - (Lubrizol Co.; Trade name: Pemulen 1622)
¹⁴Aminomethyl propanol (AMP) - (2-Amino-2-methyl-1-propanol; technical, ≥90%; Sigma-Aldrich; Item#: 08581)
¹⁵Beeswax (BW) - (beeswax, refined; Sigma-Aldrich; Item #: 243248)
¹⁶Lycopodium (Lyco) - (lycopodium; Sigma-Aldrich; Item #: 19108)
¹⁷Linear, low molecular weight polyethylene wax from New Phase Technologies

DPOD

The water-based, polyolefin dispersion (DPOD), 42% in water is a DOW HYPOD 8510 blend of two copolymers: PRIMACOR hydrophilic, polyethylene-poly(acrylic acid) copolymer, and AFFINITY hydrophobic polyethylene-octene copolymer. Here, PRIMACOR copolymer serves as a dispersant for the hydrophobic AFFINITY copolymer. One aspect that is required of DPOD is heat treatment such as that illustrated in FIG. 1. A substrate (e.g., paper, glass, aluminum, etc.) is sprayed with the formulation using the spray conditions listed in Table 2. After the substrate is uniformly coated, it is heated under the conditions also shown in Table 2. When a DPOD film is casted onto a substrate, intrinsically the surface of the DPOD film in rich in the hydrophilic PRIMACOR copolymer component. For the sample to be hydrophobic, the AFFINITY copolymer must be at the surface. A process known as phase inversion is thus required to orient the two phases of DPOD such that the surface is rich in AFFINITY copolymer and the PRIMACOR copolymer is oriented inwardly. Phase inversion depends on time, temperature, and other factors, and so rigorous heat treatment of any DPOD-containing coatings was required to render the coating hydrophobic.

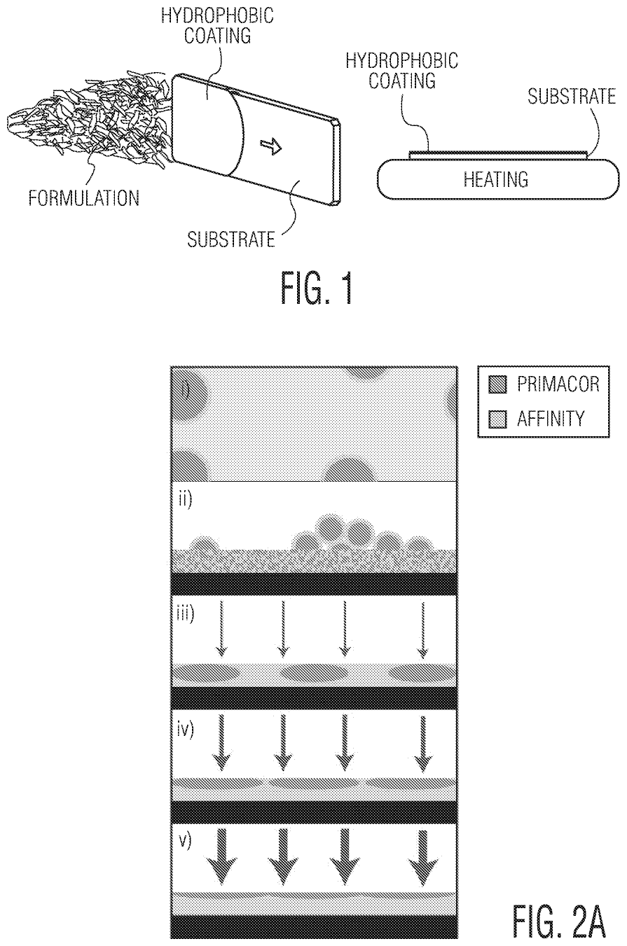

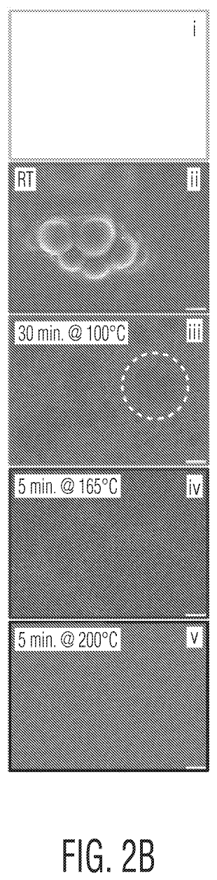

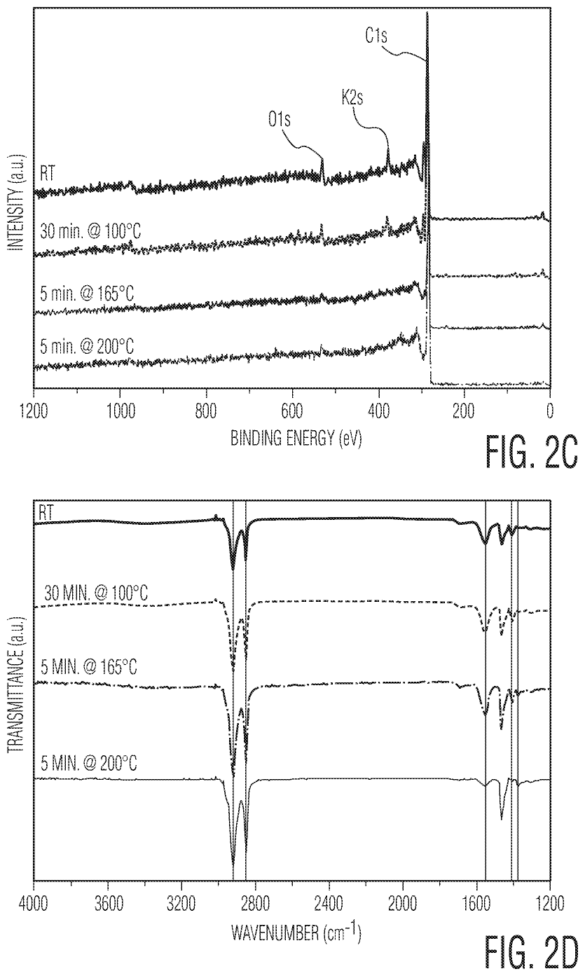

FIGS. 2A-2D illustrate the phase inversion process in more detail. FIG. 2A demonstrates the DPOD phase separation sequence: (i) DPOD in an aqueous solution, (ii) DPOD film cured at room temperature, (iii) DPOD film after mild heat treatment (30 minutes, 100° C.), (iv) DPOD film after intermediate heat treatment (5 minutes, 165° C.), and (v) DPOD film after rigorous heat treatment (5 minutes, 200° C.). The SEM images of FIG. 2B (ii) to (v), the x-ray photoelectron spectroscopy (XPS) spectra of FIG. 2C, and the Fourier transform infrared (FTIR) spectroscopy spectra of FIG. 2D illustrate the DPOD film during the phase separation process in which a DPOD film was subjected to the same heat treatment as in FIG. 2A (ii) to (v). The scale bar in each SEM image is 2 μm.

Fibrillated Cellulose

Nano-fibrillated Cellulose (NFC) was produced at Shanghai University (SU) and has characteristic fiber diameters between 100 nm and 5 μm. The NFC was treated at SU with a process that eliminates hydrogen bonding so that the cellulose fibrils do not align with each other to ultimately form a smooth film across the substrate. Instead, the process allows NFC fibrils to orient randomly. Micro/nano-fibrillated cellulose (MNFC), derived from cotton, was produced at North Carolina State University (NCSU) College of Textiles in the form of an aqueous solution (3 wt. % solids). The fibrils of the MNFC have characteristic diameters in the range of approximately 100 nm to 10 μm, and characteristic lengths of several hundred micrometers.

Crystalline Cellulose

Micro-crystalline cellulose (MCC; powder, 20 μm, Cat. No.: 310697) obtained from Sigma Aldrich has characteristic diameters of 20 μm. Surfaces are rough and uneven, but not to the extent that they introduce nano-roughness to the surfaces. MCC as received may be broken down into smaller sizes by probe sonication, which may also aid in dispersing components into solution.

Lycopodium

Lycopodium (Cat. No.: 19108) obtained from Sigma Aldrich is used as a filler instead of MCC to make the composite coatings self-cleaning. Once sprayed onto a substrate, coatings containing lycopodium display significantly better water repellency than coatings with MCC. The lycopodium particles (spores) are approximately 20 μm in diameter (similar to the size of MCC), however they also feature smaller ridge-like, polygonal structures (400-600 nm thick) protruding from the main structure (shown in SEMs). The increase in hydrophobicity is attributed to the augmented surface roughness provided by the lycopodium.

PEMULEN Emulsifier

PEMULEN 1622 emulsifier, an anionic, crosslinked copolymer of acrylic acid and C10-C30 alkyl acrylate, was obtained from Lubrizol Co. Due to pronounced swelling properties, PEMULEN emulsifier can create stable emulsions in solution, while occupying minimal area once sprayed onto a dry surface.

AKD Emulsion

An alkyl ketene dimer (AKD) emulsion was obtained in an aqueous solution from Kemira Chemicals Inc. (FENNOSIZE KD 168N, 12.5 wt. % solids in water, and only 11.2 wt. % AKD in water). The AKD was promoted with diallyldimethylammonium chloride (DADMAC), and the emulsion was stabilized with starch. Similar to DPOD-containing coatings, any coatings containing AKD also required rigorous heat treatment.

### Procedure

The formulations listed in Table 1 were prepared as follows: the hydrophobic, polymeric components (i.e., hydrophobes) were added to the filler material to achieve one of several prescribed mass fraction ratios φ, defined on a dry basis, as

$$ϕ = \frac{{m}_{f}}{{m}_{f} + {x}_{h} {m}_{h}}$$

where m_{f} represents the mass of the filler material used in the formulation, mₕ represents the mass of the hydrophobe solution used in the formulation, and xₕ denotes the effective solids content of the hydrophobe solution. Essentially, the mass fraction (φ) represents the ratio of amount of filler material to the total amount of solids within the formulation (i.e., after all of the water has evaporated). For example, a formulation consisting of 10 g of MCC and 5 g of DPOD (42% in water) would have a mass fraction as shown below.

$$ϕ = \frac{10}{10 + 0.42 * 5} = 0.192$$

Mass fractions were selected to cover range from 0 to 1 to find the optimal mass fraction (i.e., best hydrophobicity). For a given mass fraction and prescribed solids content (listed in Table 1), water (or in some cases, ammonium hydroxide solution) was added to appropriate amounts of filler material. With the exception of formulations containing α-cellulose or lycopodium, the hydrophobe solution (e.g. DPOD, AKD, etc.) was then added to the water/filler mixtures and subsequently bath sonicated under the conditions shown in Table 2. For formulations that contained either α-cellulose or lycopodium, the water/filler mixture was probe sonicated prior to adding the hydrophobe solution.

Once a formulation was made, it was sprayed onto a substrate using an airbrush sprayer. Multiple spray passes were needed to uniformly coat the substrate, so between each spray pass, excess water on the substrate was evaporated using a heat gun. This process protected the texture of the surfaces from any de-wetting effects that could compromise the integrity of the final coating. After the substrates were coated with the formulation, the samples were heat treated via hot plate. In general, a formulation's preparation/mixing conditions, spray conditions, and heating conditions, as well as the instruments used in the preparation, spray, and heating process are shown in Table 2.

Emulsion Process

Due to the harsh heating processes associated with the AKD- and/or DPOD-containing coatings, other means of creating a hydrophobizing polymer that can be used with various filler materials were employed. Wax-in-water emulsions were made using either natural waxes (e.g., carnauba wax, beeswax, etc.) or synthetic waxes (low-melting point polyethylene waxes such as PERFORMALENE polyethylene wax available from New Phase Technologies), and these emulsions essentially model the effect of DPOD. Here, the wax hydrophobes serve to replace the AFFINITY copolymer component of DPOD. An amphiphilic, polymeric emulsifier (PEMULEN 1622 emulsifier) used to stabilize the wax in an aqueous system had a role similar to the PRIMACOR copolymer component of DPOD.

The last five formulations were made using a wax emulsion as the hydrophobe component, and although different waxes were used, the process to prepare the emulsion was the same. The steps to make each emulsion were as follows:

1. Combine stabilizer (e.g., PEMULEN emulsifier) and water into a container (container A) and begin mixing at 200 rpm using an overhead stirrer. This process should be carried out while also heating the stabilizer/water mixer to a temperature above the melting point of the associated wax. In addition, because PEMULEN 1622 emulsifier is a hydroscopic powder, it should be added gradually over the course of several minutes to ensure complete hydration of the polymer.
2. Heat wax in separate container (container B).
3. Once the wax is molten, pour into container A.
4. Increase mixing speed to 800 rpm and shut off the heat.
5. Continue to mix until the solution temperature is under the melting point of the wax.
6. Neutralize the emulsion to a pH of ˜5-6 with aminomethyl propanol. This step is needed for the PEMULEN 1622 emulsifier to achieve its stabilizing properties.
7. Once neutralized, continue mixing at 400 rpm until the emulsion is cool enough to handle.

### Formulations

All of the following formulations were made by processes outlined the methods section and Table 2. In addition, the formulations were unique in terms of their mass fractions, solids contents, materials used, and processing methods. The composition of each formulation is shown in Table 3, and a brief description of each formulation is laid out below. Here, any information specific to a formulation will be presented.

TABLE 2
Processing methods for each of the formulations

| | | | | Spraying¹⁸ | | Drying | |
|---|---|---|---|---|---|---|---|
| | | Mixing | | | Coating | Process¹⁹ | |
| | | | Time | Pressure | Weight | Temperature | Time |
| Example | Formulation ID | Type | (min.) | (psi) | (gsm) | (° C.) | (min.) |
| 1 | NFC-DPOD-09 | Ultrasonic | 20 | 30 | ~45 | 150 | 10 |
| | | bath²⁰ | | | | | |
| 2 | MNFC-DPOD-09 | Ultrasonic | 20 | 30 | ~45 | 150 | 10 |
| | | bath | | | | | |
| 3 | MNFC-AKD-075 | Ultrasonic | 20 | 30 | ~45 | 150 | 10 |
| | | bath | | | | | |
| 4 | MNFC-AKD-05-A4 | Ultrasonic | 20 | 30 | ~45 | 150 | 10 |
| | | bath | | | | | |
| 5 | α-DPOD-085 | Ultrasonic | 1 | 40 | ~45 | 165 | 5 |
| | | probe²¹ | | | | | |
| 6 | α-DPOD-085-A05 | Ultrasonic | 1 | 40 | ~45 | 165 | 5 |
| | | probe | | | | | |
| 7 | MCC-DPOD-09 | Ultrasonic | 10 | 30 | ~45 | 165 | 5 |
| | | bath | | | | | |
| 8 | MCC-DPOD-09-A05 | Ultrasonic | 10 | 30 | ~45 | 165 | 5 |
| | | bath | | | | | |
| 9 | MCC-AKD-09 | Ultrasonic | 10 | 30 | ~45 | 165 | 5 |
| | | bath | | | | | |
| 10 | MCC-AKD-09-A4 | Ultrasonic | 10 | 30 | ~45 | 165 | 5 |
| | | bath | | | | | |
| 11 | MCC-DPOD-AKD-05 | Ultrasonic | 10 | 30 | ~45 | 150 | 10 |
| | | bath | | | | | |

| | | | | | | |
|---|---|---|---|---|---|---|
| 12 | MCC-CW-085 | Overhead mixer²² | 30 | ~45 | 100 | 5 |
| 13 | MCC-BW-085 | Overhead mixer | 30 | ~45 | 100 | 5 |
| 14 | Lyco-CW-075 | Overhead mixer and | 30 | ~45 | 100 | 5 |
| | | Ultrasonic probe | | | | |
| 15 | Lyco-BW-075 | Overhead mixer and | 30 | ~45 | 100 | 5 |
| | | Ultrasonic probe | | | | |
| 16 | MCC-PF400-075 | Overhead mixer | 30 | ~45 | 165 | 20 |

¹⁸Substrates were sprayed with a siphon-feed airbrush sprayer (VL sprayer; VLT-3 spray nozzle; Paasche). As the coatings required multiple passes to insure proper coverage, the substrates were heated using a heat gun (Model#: HL1810s; setting III; STEINEL Professional) in between spray passes to remove excess water.
¹⁹Hot plate - (CIMAREC Model#: sp1313250Q; Thermo Scientific)
²⁰Cole Parmer (Model#: 8891)
²¹Vibra-cell VCX750 (13 mm probe dia.; 60% amplitude; Model#: VCX 750; Sonics & Materials, Inc.)
²²Eurostar 40 digital (Model#: 4444001; IKA) using a propeller stirrer (4-bladed; Model#: 0741000; IKA)

TABLE 3
Compositions of the current formulations, in Wt. %

| | | Hydro- | Hydro- | | | pH | |
|---|---|---|---|---|---|---|---|
| Example | Formulation ID | phobe 1 | phobe 2 | Stabilizer | Filler | Adjustor | Water |
| 1 | NFC-DPOD-09 | 0.3 | | | 2.7 | | 97 |
| 2 | MNFC-DPOD-09 | 0.3 | | | 2.7 | | 97 |
| 3 | MNFC-AKD-075 | 0.75 | | 0.09 | 2.25 | | 97 |
| 4 | MNFC-AKD-05-A4 | 1.5 | | 0.17 | 1.5 | 16.5 | 80.33 |
| 5 | α-DPOD-085 | 0.71 | | | 1.7 | | 97.57 |
| 6 | α-DPOD-085-A05 | 0.71 | | | 1.7 | 3.02 | 94.58 |
| 7 | MCC-DPOD-09 | 0.48 | | | 1.8 | | 97.72 |
| 8 | MCC-DPOD-09-A05 | 0.48 | | | 1.8 | 3.03 | 94.69 |
| 9 | MCC-AKD-09 | 0.3 | | | 2.7 | | 97 |
| 10 | MCC-AKD-09-A4 | 0.3 | | | 2.7 | 29.1 | 67.9 |
| 11 | MCC-DPOD-AKD-05 | 0.75 | 0.75 | | 1.5 | | 97 |
| 12 | MCC-CW-085 | 0.45 | | 0.02 | 2.55 | 0.004 | 96.98 |
| 13 | MCC-BW-085 | 0.45 | | 0.02 | 2.55 | 0.004 | 96.98 |
| 14 | Lyco-CW-075 | 0.74 | | 0.03 | 2.25 | 0.007 | 96.97 |
| 15 | Lyco-BW-075 | 0.74 | | 0.03 | 2.25 | 0.007 | 96.97 |
| 16 | MCC-PF400-075 | 0.63 | | 0.13 | 2.25 | 0.007 | 96.99 |

*Note:
The materials used in the formulation such as the hydrophobe(s), stabilizer, filler, etc. are listed in Table 1.

All emulsions using a natural wax (e.g., carnauba wax) were made to have the composition shown in Table 4.

TABLE 4
Composition of wax emulsions

| Component | Theoretical Wt. % |
|---|---|
| Water | 87 |
| PEMULEN 1622 | 0.5 |
| emulsifier | |
| Wax | 12.5 |

*Note:
The amount of AMP used in the neutralization process is not considered here due to the fact that only enough AMP was added to successfully neutralize the PEMULEN 1622 emulsifier, which varied with solution

### Example 1

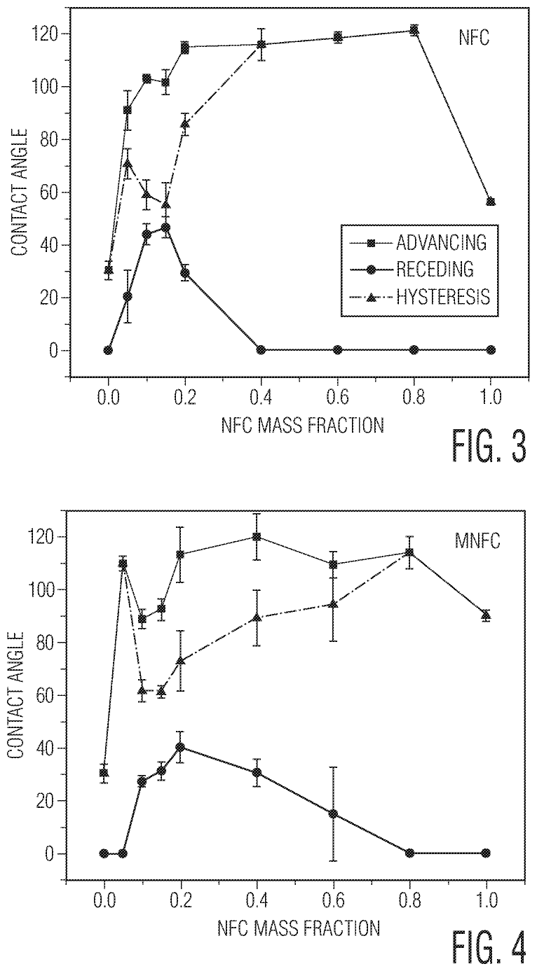

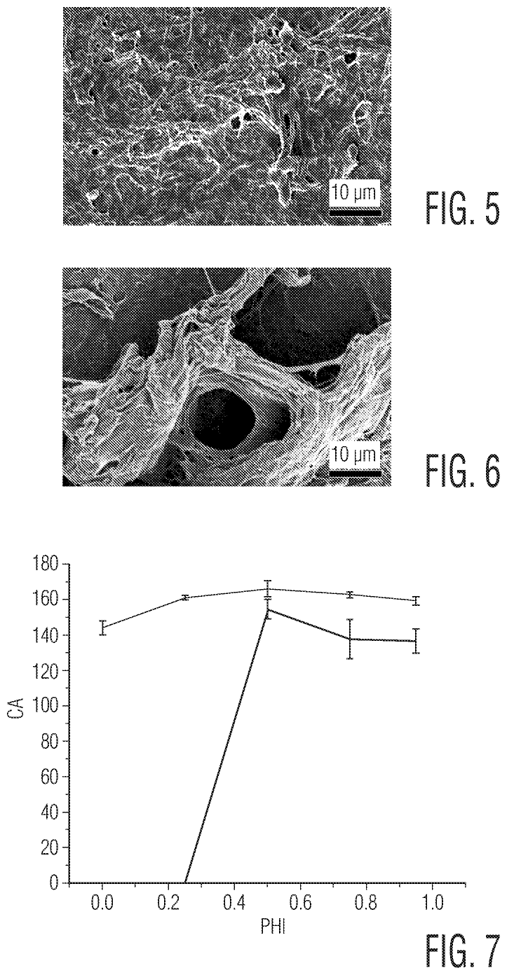

Composed of the nano-fibrillated cellulose (NFC) from Shanghai University (SU) and DPOD. The concept was that sufficient surface roughness provided by the NFC and the low surface energy of the DPOD would act in a manner similarly to that which has been reported before and create a superhydrophobic surface. However, as can be seen in the accompanying SEM (FIG. 5), the fibrils repeatedly ended up forming a film on the substrate. These coatings are not superhydrophobic (θ<150°), and in most cases, have high contact angle hysteresis. The film created by the cellulose was very adherent to glass, and fairly abrasion resistant. FIG. 3 also shows contact angle data as a function of mass fraction for the Example 1 formulation.

### Example 2

The process used for the Example 2 formulation was repeated using MNFC from North Carolina State University (NCSU). MNFC served to replace the NFC to add a microscale dimension that creates hierarchical roughness (i.e., both micro- and nano-length scale features). Despite the hierarchical roughness features (see FIG. 6), the surfaces still failed to achieve superhydrophobicity. FIG. 4 also shows contact angle data as a function of mass fraction for the Example 2 formulation. Similar to the NFC example these coatings were fairly abrasion resistant.

### Examples 3 and 4

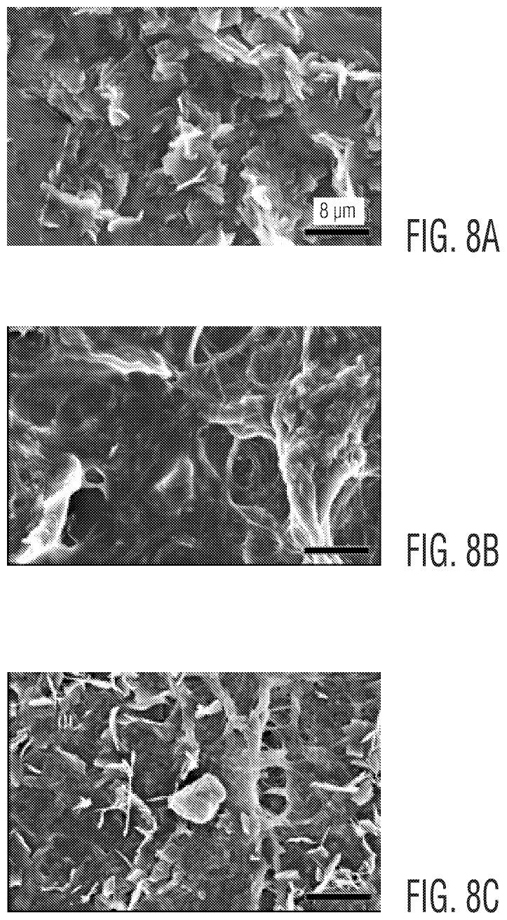

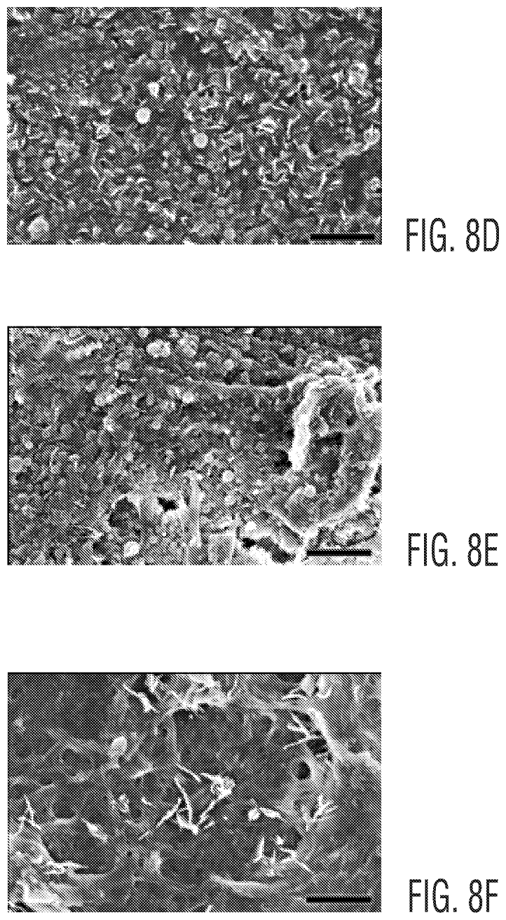

Inspired by the excellent surface roughness and adherent properties of MNFC, MNFC was combined with a polymer other than DPOD to create a superhydrophobic coating. This time (for the Example 3 formulation), an alkyl ketene dimer (AKD) emulsion was selected as it is known to work well as a hydrophobizing agent in the papermaking industry. At first, this waxy formulation did not adhere well to the substrates, so the addition of a pH adjustor (in this case, ammonium hydroxide) reacted with the AKD to form smaller features (see FIGS. 7 and 8), which made the coating much more durable. FIG. 7 shows contact angles for Example 3 after 4M NH₄OH treatment. MNFC mass fraction is shown on the horizontal, and the contact angle is given on the vertical where the difference between the two is the hysteresis. The lowest hysteresis comes at a mass fraction of 0.5. FIGS. 8A-8F present SEM images for MNFC-AKD at the scale shown in bottom right of each image (8 μm). FIGS. 8A and 8D are prepared at a mass fraction of φ=0. FIGS. 8B and 8E are prepared at a mass fraction of φ=0.5. FIGS. 8C and 8F are prepared at a mass fraction of φ=0.95. FIGS. 8A-8C are not prepared with water, while FIGS. 8D-8F are prepared in 4M NH₄OH solution. After NH₄OH treatment, as shown in FIG. 8D, the plates are no longer dominant, with slivers and spherules covering the surface. The small thin bright lines characteristic of the spherules are of high aspect ratio, and bear resemblance to the earlier plates in terms of their orientation, but on a smaller scale. It is important to note that for this formulation (Example 4), 4M ammonium hydroxide (NH₄OH) solution was added to the MNFC instead of water. Then, the AKD emulsion was added to the MNFC/NH₄OH mixture to achieve the composition listed in Table 3.

### Examples 5 and 6

The MNFC used in the above example was replaced with α-cellulose (a) obtained from Sigma-Aldrich (Example 5). The goal was to use the purest form of cellulose, α-cellulose, to eliminate any ambiguity associated with chemical treatment of the NFC or MNFC cellulose sources. This process increased the DPOD functionality and allowed surfaces coated with formulation to become superhydrophobic. Also, by avoiding the formation of a cellulose film as with the NFC and MNFC celluloses, individual cellulose particles contributed to much better hydrophobicity. There was a loss in durability of the surface, however, when switching to cellulose particles. The decrease in durability can be overcome by the addition of ammonium hydroxide. Here, a 0.5M ammonium hydroxide solution was added to the α-cellulose and subsequently probe sonicated. Then DPOD was added to the α/NH₄OH mixture to make another unique formulation (Example 6).

### Examples 7 and 8

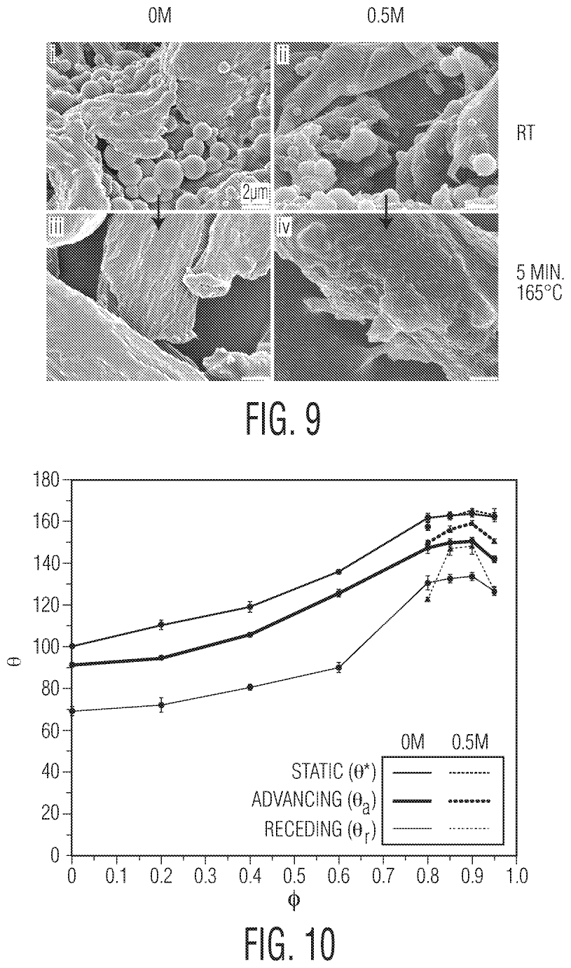

The same process for the Example 5 formulations was employed using microcrystalline cellulose (MCC), available from Sigma-Aldrich, instead of α-cellulose. The MCC has a smaller particle size than the α-cellulose, so the aim was to use the MCC in hopes of increasing the hydrophobicity by lowering the size of the cellulose particles. Here, the Example 7 coatings exhibited overall good superhydrophobicity, but they had high contact angle hysteresis (˜30°). In a similar fashion, adding ammonium hydroxide to this formulation made another unique formulation (Example 8). This process both increased the durability and aided in reducing the stickiness of the original Example 7 coatings. Here, 0.5M ammonium hydroxide (NH₄OH) solution was added to the MCC instead of water. Then, DPOD was added to the MCC/NH₄OH mixture to achieve the composition listed in Table 3. FIG. 9 illustrates coating morphology in SEM images of Example 7 (left column) and Example 8 (right column). Images (i, ii) are MCC-DPOD coatings that were cured at room temperature (RT) and that have not had sufficient temperature or time to allow for phase inversion (i.e., presence of spherules). Images (iii, iv) have been heat treated at 165° C. for 5 minutes which was enough treatment to fully phase invert the coating. FIG. 10 illustrates the apparent water contact angle (en as a function of the mass fraction (φ) of MCC in a formulation of OM MCC:DPOD and a formulation of 0.5M MCC:DPOD.

### Examples 9 and 10

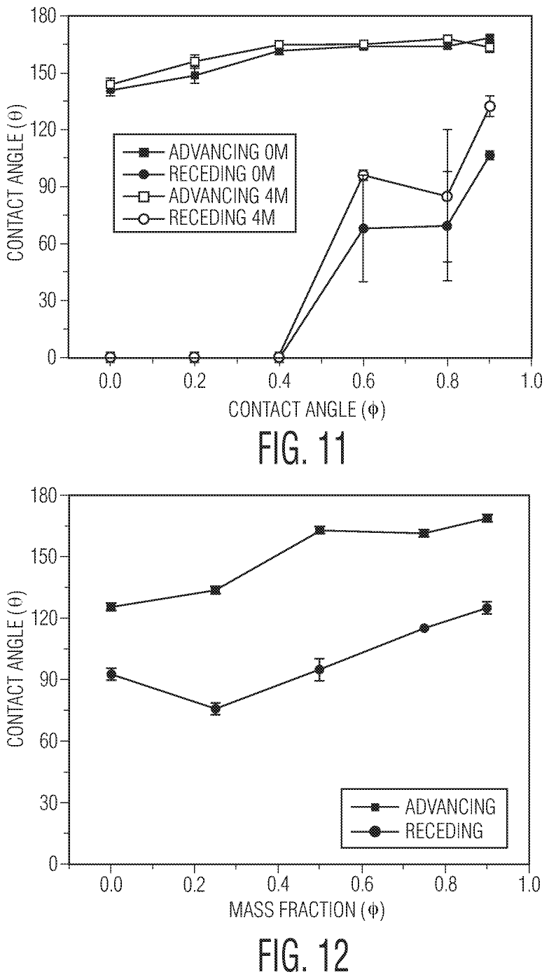

Although superhydrophobicity was achieved with the MCC:DPOD composites, the phase separation process required of the DPOD was tedious and energy consuming. Therefore, alkyl ketone dimer (AKD) was used as an alternative to DPOD in hopes that composite coatings made from MCC and AKD would not require high levels of heat treatment. MCC:AKD composite coatings were prepared at various mass fractions using the same methods as used for the preparation of the MCC:DPOD composite coatings. It was found that MCC:AKD coatings were superhydrophobic for φ>0.6, and with the best performance shown with mass fraction (φ)=0.9 (see FIG. 11). Similar to the MCC:DPOD coatings, it was found that the hydrophobicity of the MCC:AKD composite coatings (Example 9) was improved with the addition of ammonium hydroxide (4M in water; Example 10) and improved their durability (i.e. better adhesion).

### Example 11

Because there are benefits to using the DPOD (durability) and the AKD (phobicity), a combination of both combined with MCC creates a superhydrophobic surface with high durability. These surfaces require much less necessary cellulose to reach superhydrophobic performance, making them easier to process and spray while aqueous. The pH treatment is rendered unnecessary as the DPOD already acts to bolster the substrate adhesion of AKD, which was the primary benefit of adding NH₄OH. FIG. 12 shows advancing and receding contact angle measurements for the MCC:DPOD:AKD coatings (Example 11).

### Examples 12 and 13

Using the emulsion process mentioned above, carnauba wax and beeswax emulsions were prepared and ultimately used as the hydrophobe component. Example 12 includes MCC (used as filler material) and a carnauba wax emulsion that is stabilized with PEMULEN 1622 emulsifier. The carnauba wax emulsion was replaced with a beeswax emulsion (also stabilized with PEMULEN 1622 emulsifier) to make the Example 13 formulation. As can be seen from Table 1, the Example 12 formulation had better hydrophobic properties of the two natural wax systems with θ=150° and a CAH of 25°. Although the Example 13 formulation had a high contact angle, it was less hydrophobic than the formulation containing carnauba wax.

### Examples 14 and 15

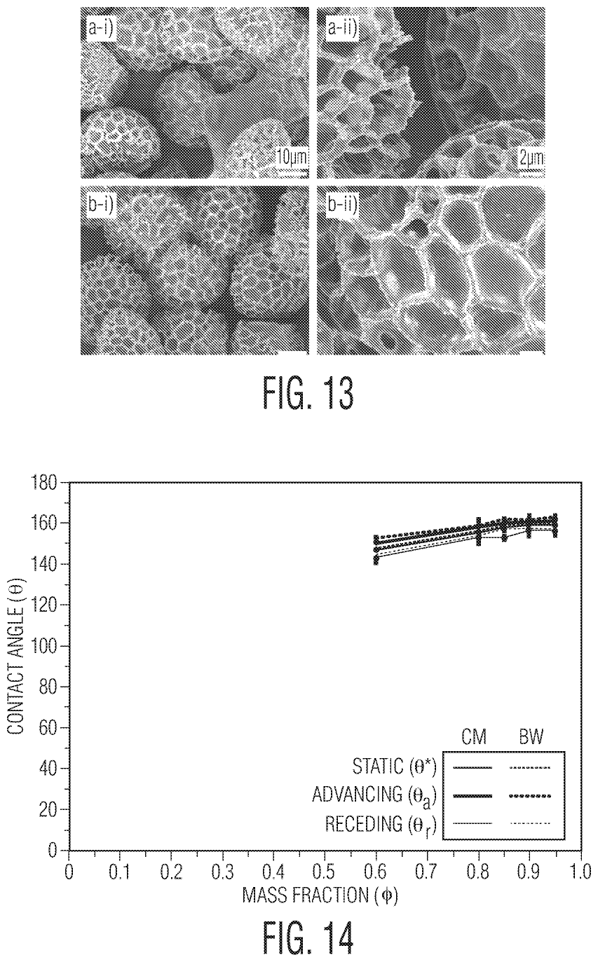

Similar to the previous two formulations, these formulations also used the carnauba wax and beeswax emulsions. Instead of using MCC as the filler material to provide surface texture, however, lycopodium was used. Lycopodium is a spore-like particle derived from ground pine, and has a similar characteristic size as the MCC. One difference between MCC and lycopodium is that lycopodium has smaller length-scale features. These smaller features greatly increased the hydrophobicity of coatings made of these formulations. FIG. 13 shows scanning electron microscopy images of lycopodium with (a) carnauba wax and (b) beeswax. Both the Example 14 and Example 15 formulations have high water contact angles (162° or higher) and extremely low contact angle hysteresis)(<5°, and, although the Example 14 formulation performs slightly better, both formulations are superhydrophobic. It is also important to note that both of these formulations have ranges for optimal mass fractions, which is due to the fact that lycopodium is hydrophobic. FIG. 14 shows the contact angle data for the lycopodium and natural wax coatings.

### Example 16

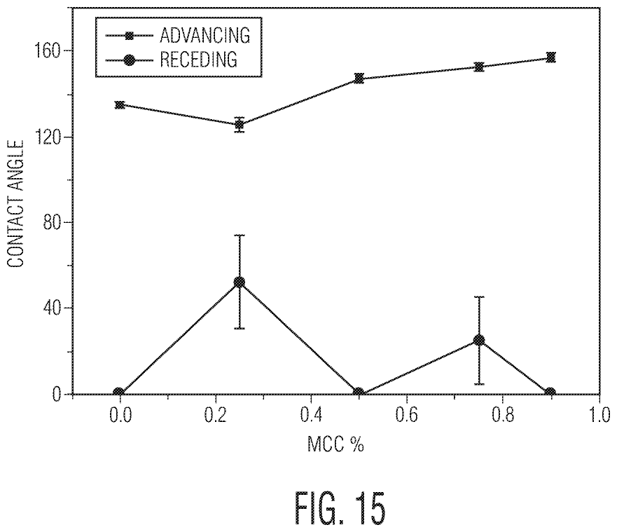

Using the emulsion process mentioned above, PERFORMALENE polyethylene wax emulsions were prepared and ultimately used as the hydrophobe component. The Example 16 formulation includes of MCC (used as filler material) and a PERFORMALENE 400 polyethylene wax emulsion that was stabilized with PEMULEN 1622 emulsifier. Contrary to Table 4, the ratio of PEMULEN 1622 emulsifier to wax in this solution was 1:5, which could be reduced to some extent. As can be seen from FIG. 15, the receding angles were absent in certain locations across the coating, indicating that while the wax was repellent to the water, the PEMULEN 1622 emulsifier content on the surface was so great that it began to dissolve. Reducing this content is critical to realizing low hysteresis.

In a first particular aspect, non-fluorinated composition configured to create a superhydrophobic surface includes a hydrophobic matrix component free of fluorine; filler particles, wherein the filler particles are plant-based elements of a size ranging from 100 nm to 100 μm; and water, wherein the hydrophobic matrix component is in an aqueous dispersion.

A second particular aspect includes the first particular aspect, wherein the plant-based elements are particles and/or fibers.

A third particular aspect includes the first and/or second aspect, wherein the plant-based elements include micro- and nano-fibrillated cellulose.

A fourth particular aspect includes one or more of aspects 1-3, wherein the plant-based elements include lycopodium.

A fifth particular aspect includes one or more of aspects 1-4, wherein the hydrophobic matrix component is a polymer.

A sixth particular aspect includes one or more of aspects 1-5, wherein the hydrophobic matrix component includes a polyolefin, a natural wax, or a synthetic wax.

A seventh particular aspect includes one or more of aspects 1-6, wherein the natural wax is carnauba wax or beeswax.

An eighth particular aspect includes one or more of aspects 1-7, wherein the synthetic wax is a polyolefin wax.

A ninth particular aspect includes one or more of aspects 1-8, further comprising an emulsifier.

A tenth particular aspect includes one or more of aspects 1-9, wherein the hydrophobic matrix component includes a co-polymer of olefin and acrylic acid.

An eleventh particular aspect includes one or more of aspects 1-10, wherein the hydrophobic matrix component includes an alkyl ketene dimer (AKD) emulsion.

A twelfth particular aspect includes one or more of aspects 1-11, wherein the composition is free of volatile organic compounds.

A thirteenth particular aspect includes one or more of aspects 1-12, wherein the composition is configured to be applied to a surface such that the surface exhibits a contact angle greater than 150 degrees.

A fourteenth particular aspect includes one or more of aspects 1-13, wherein the hydrophobic matrix component and cellulosic elements are present in an amount of from about 0.1% to about 10.0%, by weight of the dispersion.

In a fifteenth particular aspect, a non-fluorinated composition configured to create a superhydrophobic surface includes a hydrophobic matrix component free of fluorine; filler particles, wherein the filler particles are plant-based elements of a size ranging from 100 nm to 100 μm, and wherein the plant-based elements are micro- and nano-fibrillated cellulose; and water.

A sixteenth particular aspect includes the fifteenth aspect, wherein the hydrophobic matrix component includes a co-polymer of olefin and acrylic acid.

A seventeenth particular aspect includes the fifteenth and/or sixteenth aspects, wherein the hydrophobic matrix component includes an alkyl ketene dimer (AKD) emulsion.

An eighteenth particular aspect includes one or more of aspects 15-17, further comprising an emulsifier.

A nineteenth particular aspect includes one or more of aspects 15-18, wherein the composition is configured to be applied to a surface such that the surface exhibits a contact angle greater than 150 degrees.

In a twentieth particular aspect, a non-fluorinated composition configured to create a superhydrophobic surface includes a hydrophobic matrix component free of fluorine, wherein the hydrophobic matrix component includes a polyolefin, a natural wax, or a synthetic wax; filler particles, wherein the filler particles are plant-based elements of a size ranging from 100 nm to 100 μm; an emulsifier; and water, wherein the hydrophobic component is in an aqueous dispersion

All documents cited herein are, in relevant part, incorporated herein by reference; the citation of any document is not to be construed as an admission that it is prior art with respect to the present disclosure. To the extent that any meaning or definition of a term in this document conflicts with any meaning or definition of the same term in a document incorporated by reference, the meaning or definition assigned to that term in this document shall govern.

While particular aspects of the present disclosure have been illustrated and described, it would be obvious to those skilled in the art that various other changes and modifications can be made without departing from the spirit and scope of the disclosure. It is therefore intended to cover in the appended claims all such changes and modifications that are within the scope of this disclosure.

What is claimed is:

1. A non-fluorinated composition configured to create a superhydrophobic surface, the composition comprising:
a hydrophobic matrix component free of fluorine;
filler particles, wherein the filler particles are plant-based elements of a size ranging from 100 nm to 100 μm; and
water, wherein the hydrophobic matrix component is in an aqueous dispersion.

2. The non-fluorinated composition of claim 1, wherein the plant-based elements are particles and/or fibers.

3. The non-fluorinated composition of claim 1, wherein the plant-based elements include micro- and nano-fibrillated cellulose.

4. The non-fluorinated composition of claim 1, wherein the plant-based elements include lycopodium.

5. The non-fluorinated composition of claim 1, wherein the hydrophobic matrix component is a polymer.

6. The non-fluorinated composition of claim 1, wherein the hydrophobic matrix component includes a polyolefin, a natural wax, or a synthetic wax.

7. The non-fluorinated composition of claim 6, wherein the natural wax is carnauba wax or beeswax.

8. The non-fluorinated composition of claim 6, wherein the synthetic wax is a polyolefin wax.

9. The non-fluorinated composition of claim 1, further comprising an emulsifier.

10. The non-fluorinated composition of claim 1, wherein the hydrophobic matrix component includes a co-polymer of olefin and acrylic acid.

11. The non-fluorinated composition of claim 1, wherein the hydrophobic matrix component includes an alkyl ketene dimer (AKD) emulsion.

12. The non-fluorinated composition of claim 1, wherein the composition is free of volatile organic compounds.

13. The non-fluorinated composition of claim 1, wherein the composition is configured to be applied to a surface such that the surface exhibits a contact angle greater than 150 degrees.

14. The non-fluorinated composition of claim 1, wherein the hydrophobic matrix component and cellulosic elements are present in an amount of from about 0.1% to about 10.0%, by weight of the dispersion.

15. A non-fluorinated composition configured to create a superhydrophobic surface, the composition comprising:
a hydrophobic matrix component free of fluorine;
filler particles, wherein the filler particles are plant-based elements of a size ranging from 100 nm to 100 μm, and wherein the plant-based elements are micro- and nano-fibrillated cellulose; and
water.

16. The non-fluorinated composition of claim 15, wherein the hydrophobic matrix component includes a co-polymer of olefin and acrylic acid.

17. The non-fluorinated composition of claim 15, wherein the hydrophobic matrix component includes an alkyl ketene dimer (AKD) emulsion.

18. The non-fluorinated composition of claim 15, further comprising an emulsifier.

19. The non-fluorinated composition of claim 15, wherein the composition is configured to be applied to a surface such that the surface exhibits a contact angle greater than 150 degrees.

20. A non-fluorinated composition configured to create a superhydrophobic surface, the composition comprising:
a hydrophobic matrix component free of fluorine, wherein the hydrophobic matrix component includes a polyolefin, a natural wax, or a synthetic wax;
filler particles, wherein the filler particles are plant-based elements of a size ranging from 100 nm to 100 μm;
an emulsifier; and
water, wherein the hydrophobic component is in an aqueous dispersion.
